(19) United States
(12) Patent Application Publication
(10) Pub. No.: US 2025/0310928 A1
(43) Pub. Date: Oct. 2, 2025

(54) METHODS AND DEVICES FOR ON-DEMAND POSITIONING

(71) Applicant: Sony Group Corporation, Tokyo (JP)

(72) Inventors: Basuki PRIYANTO, Lund (SE); Johan HILL, Lund (SE)

(21) Appl. No.: 19/231,822

(22) Filed: Jun. 9, 2025

Related U.S. Application Data
(63) Continuation of application No. 17/633,309, filed on Feb. 7, 2022, now abandoned.

(30) Foreign Application Priority Data
Aug. 15, 2019 (SE) 1930269-4

(51) Int. Cl. H04W 64/00

(52) U.S. Cl. CPC H04W 64/00

(57) ABSTRACT

A positioning operation for a user equipment (UE) involves a two-step process having a coarse positioning followed by a refined positioning. The coarse positioning can be based on periodic reference signals from a first set of network nodes. A refined positioning specific to the UE is configured based on the coarse positioning. The refined positioning can include targeted transmissions of reference signals to the UE by a second set of network nodes.

### RELATED APPLICATION DATA

This application is continuation of U.S. patent application Ser. No. 17/633,309, filed Feb. 7, 2022. Application Ser. No. 17/633,309 is a national stage application of PCT/US2020/040981, filed Jul. 7, 2020. International Application No. PCT/US2020/040981 claims the benefit of Swedish Patent Application No. 1930269-4, filed Aug. 15, 2019. The entireties of the aforementioned patent applications are incorporated herein by reference.

### TECHNICAL FIELD OF THE INVENTION

The technology of the present disclosure relates generally to operations of a network node and/or a wireless communications device in a wireless communications network and, more particularly, to methods and apparatus for positioning of a device.

### BACKGROUND

In existing wireless communications systems (e.g., 3G or 4G-based systems), estimations of a device position are generally considered acceptable when regulatory positioning requirements are satisfied. For example, for emergency calls, a position estimate is only required to be accurate within 50 meters in 4G systems. Positioning is an important feature under consideration of the Third Generation Partnership Project (3GPP) for 5G systems such as New Radio (NR). The specification is targeting use cases beyond emergency call services (i.e. regulatory requirements), such as commercial use-cases and 5G systems may be expected to provide sub-meter positioning accuracy.

Cellular-based positioning may be downlink based or uplink based. In legacy systems, timing measurements and angle measurements are common techniques in downlink-based positioning. For instance, observed time difference of arrival (OTDOA) is a multilateration technique in 4G systems. In this technique, a base station (eNB) transmits positioning reference signals (PRS). A user equipment (UE) estimates time of arrival (TOA) based on the received PRS. The TOA measured from the PRS of multiple base stations are subtracted from a TOA corresponding to a reference base station to generate OTDOA measurements. The UE reports the OTDOA measurements or measured time difference (e.g. Reference Signal Time Difference (RSTD)) to a location server. The location server estimates the position of the UE based on the RSTD report and known coordinates of the base stations. Another technique, such as Enhanced cell ID with LTE systems, involves a base station estimating an angle of arrival (AoA) of a signal transmitted by the UE. The base station exploits phase difference from at least two receive antennas to estimate the AoA, for example.

One approach in legacy systems for uplink-based positioning is uplink time difference of arrival (UTDOA). With this approach, a user equipment (UE) transmits a reference signal, which is received by one or more base stations or dedicated location measurement units (LMUs). The base stations (or LMUs) estimate a time of arrival and report the estimate to a location server to estimate the UE's position (e.g. via multilateration if multiple base stations measure a time of arrival).

### SUMMARY

In legacy systems, positioning of a UE, in particular downlink-based positioning, is based on periodic signals (e.g. positioning reference signal (PRS) or other reference signal) broadcasted by base stations. In NR systems, support for similar downlink-based positioning has been considered. In principle, base stations in an NR system transmit PRS and a UE calculates a time of arrival (ToA) from each base station. Typically, the UE measures ToA from at least three base stations in order to perform positioning estimation. NR systems support transmissions with a beam direction as opposed to omni-directional or sectorized transmissions as with legacy systems. In order to provide good coverage (e.g. in multiple directions), a base station may transmit PRS using a beam sweeping operation to cover all directions. Signaling overhead is a balancing consideration. While a base station may be operable to transmit using very narrow beams (in terms of beam width), there would be high signaling overhead since the resultant beam sweeping operation would significantly increase resources reserved for PRS transmission.

Given the above considerations related to coverage and overhead, PRS may be transmitted with a relatively wide beam. Reasonable positioning accuracy, particularly for emergency calling, may be obtained with this setup. In 5G NR systems, use-cases for positioning may not be limited to emergency call support and may include commercial use-cases. These use-cases may demand various parameters for positioning results (e.g. vertical positioning, horizontal positioning, mobility, and/or latency) and various accuracy requirements (e.g. within hundreds of meters, within tens of meters, or sub-meter). Legacy approaches may not be able to achieve these requirements. Moreover, legacy positioning techniques are designed to generically support all UEs. UEs may have different UE-specific levels of positioning accuracy and/or latency.

To support high accuracy in positioning, while also improving coverage with low signaling overhead, techniques described herein relate to on-demand positioning of a UE. The disclosed approach enables selected base stations to target a UE and transmit reference signals, on-demand, in a selected beam direction identified by the UE as preferred. These targeted transmissions may improve accuracy and decrease latency in positioning by enabling higher quality positioning measurements by the UE.

According to one aspect of the disclosure, a method, performed by a wireless communications device, for positioning of the wireless communications device includes: receiving configuration information for targeted transmissions from a first set of network nodes usable for a positioning operation, the targeted transmissions being specific for the wireless communications device; receiving one or more targeted reference signals respectively from the first set of network nodes based on the configuration information; and performing positioning measurements on the one or more reference signals received.

According to one embodiment, prior to receiving the configuration information the method includes: receiving one or more general reference signals from a second set of network nodes; performing initial positioning measurements on the one or more general reference signals; and transmitting a measurement report to a serving network node.

According to one embodiment, the method further includes transmitting a beam measurement request to the serving network node for transmission of the targeted reference signals from the first set of network nodes selected from the second set of network nodes.

According to one embodiment of the method, the measurement report identifies selected transmit beams on which the wireless communications device respectively receives general reference signals from the second set of network nodes, the selected transmit beams indicate preferred beams to assist configuration of the targeted transmissions.

According to one embodiment, the method further includes receiving the one or more targeted reference signals on respective sets of transmit beams from the first set of network nodes.

According to one embodiment of the method, the configuration information includes an association of the respective sets of transmit beams to selected transmit beams.

According to one embodiment of the method, the configuration information includes at least respective resource information for the one or more targeted reference signals respectively transmitted by the first set of network nodes.

According to another aspect of the disclosure, a method for facilitating positioning of a wireless communications device, performed by a network node, includes: transmitting a general reference signal via a first set of transmit beams; and transmitting a targeted reference signal specific to the wireless communications device via a second set of transmit beams, wherein transmitting the targeted reference signal is based at least in part on information reported by the wireless communications device after receiving the periodic reference signal.

According to one embodiment of the method, the information reported by the wireless communications device indicates a selected beam from the first set of transmit beams, and the second set of transmit beams include transmit beams that are determined based on the selected beam.

According to one embodiment, the method further includes receiving a request to transmit the target reference signal following transmission of the general reference signal.

According to one embodiment, the network node is a serving network node and the method and the method further includes: receiving a measurement report from the wireless communications device based on general reference signals received by the wireless communications device; determining resources for transmitting the target reference signal to the wireless communications device based at least in part on the measurement report; and requesting a set of neighbor network nodes to transmit target reference signals to the wireless communications device based at least in part on the measurement report.

According to one embodiment, the network node is a serving network node and the method further includes: negotiating resources for transmission of target reference signals by the set of neighbor network nodes; and transmitting configuration information to the wireless communications device that indicates at least resources determined for transmissions of target reference signals by the serving network node and the set of neighbor network nodes.

According to one embodiment, the method includes selecting the set of neighbor network nodes based at least in part on the measurement report.

According to another aspect of the disclosure, a wireless communications device configured to operate in a wireless communications network includes a wireless interface over which wireless communications with one or more network nodes are carried out; and a control circuit configured to: receive configuration information for targeted transmissions from a first set of network nodes usable for a positioning operation, the targeted transmissions being specific for the wireless communications device; receive one or more targeted reference signals respectively from the first set of network nodes based on the configuration information; and perform positioning measurements on the one or more reference signals received.

According to one embodiment of the wireless communications device, prior to receiving the configuration information, the control circuit is further configured to: receive one or more general reference signals from a second set of network nodes; perform initial positioning measurements on the one or more general reference signals; and transmit a measurement report to a serving network node.

According to one embodiment of the wireless communications device, the control circuit is further configured to transmit a beam measurement request to the serving network node for transmission of the targeted reference signals from the first set of network nodes selected from the second set of network nodes.

According to one embodiment of the wireless communications device, the measurement report identifies selected transmit beams on which the wireless communications device respectively receives general reference signals from the second set of network nodes, the selected transmit beams indicate preferred beams to assist configuration of the targeted transmissions.

According to one embodiment of the wireless communications device, the control circuit is further configured to receive the one or more targeted reference signals on respective sets of transmit beams from the first set of network nodes.

According to one embodiment of the wireless communications device, the configuration information includes an association of the respective sets of transmit beams to selected transmit beams.

According to one embodiment of the wireless communications device, the configuration information includes at least respective resource information for the one or more targeted reference signals respectively transmitted by the first set of network nodes.

According to another aspect of the disclosure, a network node configured to operate in a wireless communications network includes an interface over which communications are carried out; and a control circuit configured to: transmit a general reference signal via a first set of transmit beams; and transmit a targeted reference signal specific to a wireless communications device via a second set of transmit beams, wherein transmitting the targeted reference signal is based at least in part on information reported by the wireless communications device after receiving the periodic reference signal.

According to one embodiment of the network node, the information reported by the wireless communications device indicates a selected beam from the first set of transmit beams, and the second set of transmit beams include transmit beams that are determined based on the selected beam.

According to one embodiment of the network node, the control circuit is further configured to receive a request to transmit the target reference signal following transmission of the general reference signal.

According to one embodiment, the network node is a serving network node and the control circuit is further configured to: receive a measurement report from the wireless communications device based on general reference signals received by the wireless communications device; determine resources for transmitting the target reference signal to the wireless communications device based at least in part on the measurement report; and request a set of neighbor network nodes to transmit target reference signals to the wireless communications device based at least in part on the measurement report.

According to one embodiment of the network node, the control circuit is further configured to: negotiate resources for transmission of target reference signals by the set of neighbor network nodes; and transmit configuration information to the wireless communications device that indicates at least resources determined for transmissions of target reference signals by the serving network node and the set of neighbor network nodes.

According to one embodiment of the network node, the control circuit is further configured to select the set of neighbor network nodes based at least in part on the measurement report.

### BRIEF DESCRIPTION OF THE DRAWINGS

FIG. 1 is a schematic block diagram of a representative operational network environment for a wireless communications device, also referred to as a user equipment (UE).

FIG. 2 is a schematic block diagram of a radio access network (RAN) node from the network environment.

FIG. 3 is a schematic block diagram of the UE from the network environment.

FIG. 4 is a schematic block diagram of a positioning computation node from the network environment.

FIG. 5 is a schematic diagram of an exemplary positioning technique.

FIG. 6 is a schematic diagram of an exemplary positioning technique.

FIG. 7a is a signaling diagram of an exemplary embodiment of a procedure for on-demand positioning of a UE.

FIG. 7b is a signaling diagram of an exemplary embodiment of a procedure for on-demand positioning of a UE.

FIG. 8 is a flow diagram of a representative method for on-demand positioning of a wireless communications device, performed at a serving network node.

FIG. 9 is a flow diagram of a representative method for on-demand positioning of a wireless communications device, performed at a neighbor network node.

FIG. 10 is a flow diagram of a representative method for on-demand positioning of a wireless communications device, performed at the wireless communications device.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

### System Architecture

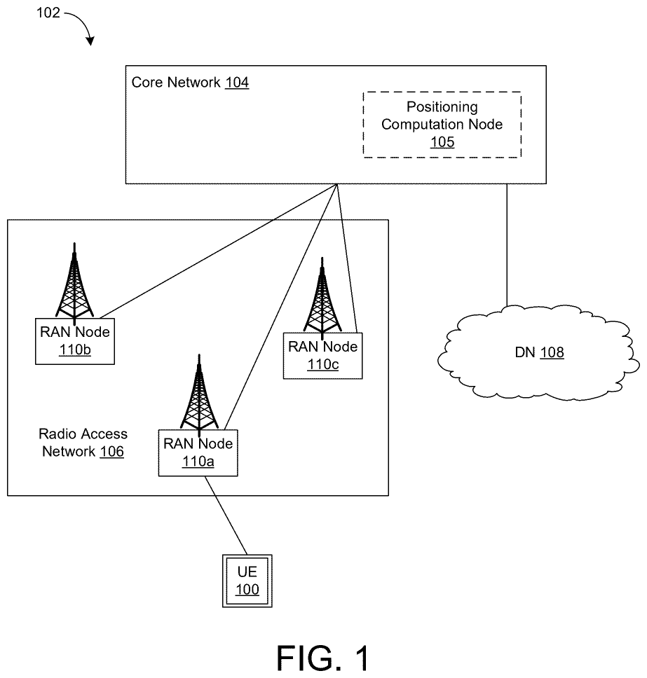

FIG. 1 is a schematic diagram of an exemplary network environment in which the disclosed techniques are implemented. It will be appreciated that the illustrated network environment is representative and other environments or systems may be used to implement the disclosed techniques. Also, various functions may be carried out by a single device, such as by a radio access node, user equipment, or core network node, may be carried out in a distributed manner across nodes of a computing or wireless communications environment.

The network environment is relative to an electronic device, such as a user equipment (UE) 100. As contemplated by 3GPP standards, the UE may be a mobile radiotelephone (a “smartphone”). Other exemplary types of UEs 100 include, but are not limited to, a gaming device, a media player, a tablet computing device, a computer, a camera, and an internet of things (IoT) device. Since aspects of the disclosed techniques may be applicable to non-3GPP networks, the UE 100 may be more generically referred to as a wireless communications device or a radio communications device.

The network environment includes a wireless communications network 102 that may be configured in accordance with one or more 3GPP standards, such as a 3G network, a 4G network or a 5G network. The disclosed approaches may apply to other types of networks.

In instances where the network 102 is a 3GPP network, the network 102 includes a core network (CN) 104 and a radio access network (RAN) 106. The core network 104 provides an interface to a data network (DN) 108. The DN 108 represents operator services, connection to the Internet, third party services, etc. Details of the core network 104 are omitted for simplicity of description, but it is understood that the core network 104 includes one or more servers that host a variety of network management functions, examples of which include, but are not limited to, a user plane function (UPF), a session management function (SMF), a core access and mobility management function (AMF), an authentication server function (AUSF), a network exposure function (NEF), a network repository function (NRF), a policy control function (PCF), a unified data management (UDM), an application function (AF), and a network slice selection function (NSSF). In addition, the core network 104 may include a positioning computation node 105 configured to estimate a position of UE 100 based on measurements reported by the UE 100 for downlink-based positioning, measurements reported by the RAN 106, for example, with uplink-based positioning, or a combination of both as described herein. As discussed later, the positioning computation node 105 may request the UE 100 and/or RAN 106 to support dual-direction positioning. Further, while shown in FIG. 1 as being included in the core network 104, the positioning computation node 105 may be included in any network node, including nodes of RAN 106, or device, such as UE 100.

The RAN 106 includes a plurality of RAN nodes 110. In the illustrated example, there are three RAN nodes 110a, 110b, and 110c. Fewer than or more than three RAN nodes 110 may be present. For 3GPP networks, each RAN node 110 may be a base station such as an evolved node B (eNB) base station or a 5G generation gNB base station. The RAN node 110 may include one or more Tx/Rx points (TRPs). Since aspects of the disclosed techniques may be applicable to non-3GPP networks, the RAN nodes 110 may be more generically referred to as network access nodes or network nodes, an alternative example of which is a WiFi access point.

A radio link may be established between the UE 100 and one of the RAN nodes 110 for providing wireless radio services to the UE 100. The RAN node 110 to which the radio link is established will be referred to as the serving RAN node 110 or serving base station. Other RAN nodes 110 may be within communication range of the UE 100. The RAN 106 is considered to have a user plane and a control plane. The control plane is implemented with radio resource control (RRC) signaling between the UE 100 and the RAN node 110. Another control plane between the UE 100 and the core network 104 may be present and implemented with non-access stratum (NAS) signaling.

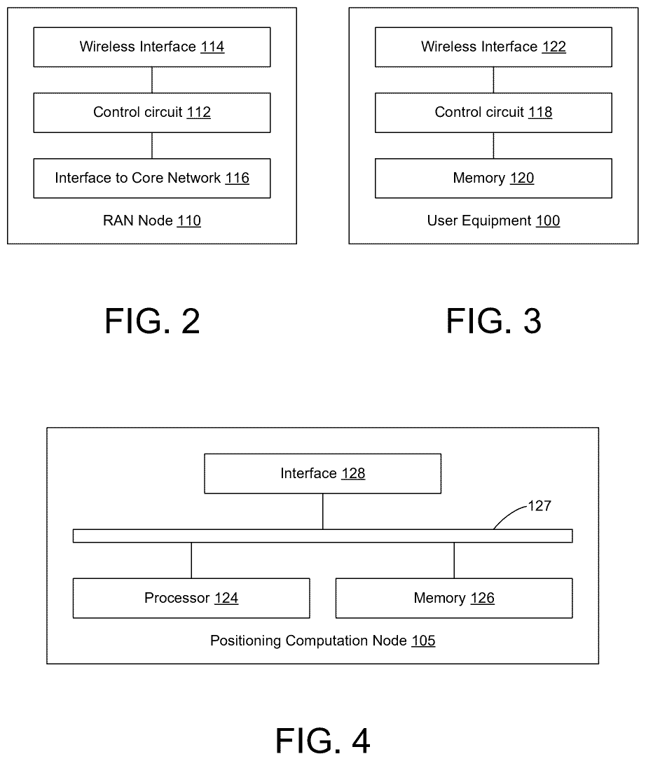

With additional reference to FIG. 2, each RAN node 110 typically includes a control circuit 112 that is responsible for overall operation of the RAN node 110, including controlling the RAN node 110 to carry out the operations described in herein. In an exemplary embodiment, the control circuit may include a processor (e.g., a central processing unit (CPU), microcontroller, or microprocessor) that executes logical instructions (e.g., lines of code, software, etc.) that are stored by a memory (e.g., a non-transitory computer readable medium) of the control circuit 112 in order to carry out operation of the RAN node 110.

The RAN node 110 also includes a wireless interface 114 for establishing an over the air connection with the UE 100. The wireless interface 114 may include one or more radio transceivers and antenna assemblies to form the TRP(s). The RAN node 110 also includes an interface 116 to the core network 104. The RAN node 110 also includes an interface (not shown) to one or more neighboring RAN nodes 110 for conducting network coordination in the RAN 106.

In accordance with a further aspect, the network 102 may include a location measurement unit (LMU). The LMU may be a separate node (e.g. within the RAN 106 or CN 104) or it may be co-located with or a component of the RAN node 110. For example, the LMU may be a computer-based system communicatively coupled with and positioned near the RAN node 110. Alternatively, the LMU may be integrated into the RAN node 110 and may be implemented in by the logical instructions stored in the memory of the control circuit 112.

In accordance with a further aspect, the RAN node 110 may also include a similar function of positioning computation node 105. The RAN node 100 may include a positioning computation node 105 with limited functionality. For example, the RAN node 110 may include functionality that enables it to receive and process the UE positioning measurement. Based on the measurement and post-processing, the RAN node 110 can signal and coordinate with other RAN nodes 110.

With additional reference to FIG. 3, illustrated is a schematic block diagram of the UE 100. The UE 100 includes a control circuit 118 that is responsible for overall operation of the UE 100, including controlling the UE 100 to carry out the operations described herein. In an exemplary embodiment, the control circuit 118 may include a processor (e.g., a central processing unit (CPU), microcontroller, or microprocessor) that executes logical instructions (e.g., lines of code, software, etc.) that are stored by a memory (e.g., a non-transitory computer readable medium) of the control circuit 118 or a separate memory 120 in order to carry out operation of the UE 100.

The UE 100 includes a wireless interface 122, such as a radio transceiver and antenna assembly, for establishing an over the air connection with the serving base station 110. In some instances, the UE 100 may be powered by a rechargeable battery (not shown). Depending on the type of device, the UE 100 may include one or more other components. Other components may include, but are not limited to, sensors, displays, input components, output components, electrical connectors, etc.

In FIG. 4, a schematic block diagram of an exemplary embodiment of a positioning computation node 105 is illustrated. The positioning computation node 105 executes logical instructions (e.g., in the form of one or more software applications) to generate positioning estimates. It is to be understood, however, that aspects of the positioning computation node 105 may be distributed across various nodes of the core network 104 or another computing environment.

The positioning computation node 105 may be implemented as a computer-based system that is capable of executing computer applications (e.g., software programs) that carry out functions of the computation node 105. As is typical for a computer platform, the positioning computation node 105 may include a non-transitory computer readable medium, such as a memory 126 that stores data, information sets and software, and a processor 124 for executing the software. The processor 124 and the memory 126 may be coupled using a local interface 127. The local interface 127 may be, for example, a data bus with accompanying control bus, a network, or other subsystem. The computation node 105 may have various input/output (I/O) interfaces for operatively connecting to various peripheral devices, as well as one or more interfaces 128. The interface 128 may include for example, a modem and/or a network interface card. The communications interface 128 may enable the computation node 105 to send and receive data signals to and from other computing devices in the core network 104, the RAN 106, and/or in other locations as is appropriate.

### On-Demand Positioning

As described above, legacy positioning techniques may not be able to achieve a required accuracy without significant latency. The delay in obtaining an accurate position may in part be to the time necessary to acquire a sufficient number of measurements based on transmissions of general reference signals that may occur only periodically. However, in cases of increased mobility, even compiling many measurements based on periodic transmissions may not be enough. Techniques will be described for supporting accurate, low latency positioning of a wireless communications device in an on-demand manner.

In one embodiment, on-demand positioning as described herein may involve identifying preferred beam pairs between a wireless communications device and a set of network nodes (e.g. RAN nodes). Beam pairs may be maintained in connected mode for a serving cell with narrow beams (e.g. in terms of beam width) for data and control channels. These beam pairs may be maintained utilizing channel state information-reference signals (CSI-RS). For positioning purposes, more than one cell is utilized. Neighboring cells may be measured at certain time intervals. Beam pairs for neighboring cells are typically monitored using synchronization signal blocks (SSBs), which may be a wider beam. In idle or inactive mode, cells may still be monitored, but on an SSB level with wider beams.

To illustrate measurement at the SSB level, a measurement gap may be scheduled for a wireless communications device to measure neighboring cells in connected, idle, or inactive mode. Initially, these measurements are used to synchronize to the cells since locations and paths between the transmission points (e.g. neighboring base stations) and the wireless communications device are different than with a serving cell. The transmission points (e.g. neighboring base stations) transmit SSBs that include two synchronization reference signals (e.g. primary synchronization signal (PSS) and secondary synchronization signal (SSS)) and a broadcast channel (e.g. physical broadcast channel (PBCH)). The SSB can be transmitted using beams, but the beams may be different from beams likely used for other channels. By measuring a SSB, the wireless communications device obtains a value indicating how strong a cell is received, a cell ID of the cell, and a beam pair configuration. The beam pair configuration includes a receive beam used by the wireless communications device and a transmit beam used by the transmission point of the cell.

According to an example, a wireless communications device (e.g. UE 100) may request or be requested to perform a positioning operation. For instance, a node of the wireless communication network (such as the positioning computation node 105 and/or a RAN node 110) may trigger positioning/localization request of the wireless communications device. Alternatively, the wireless communication device may trigger the wireless communications network to perform or support the positioning operation.

In an initial step, the wireless communications device measures reference signals from a set of cells or network nodes. The set may include a serving network node and one or more neighboring network nodes. The network nodes may periodically transmit general reference signals. The reference signals may, in one example, be positioning reference signals (PRS) similar to PRS in legacy systems. In another example, other existing signals generally utilized to assist data transmissions may be used for positioning purposes. For instance, channel state information-reference signal (CSI-RS), tracking reference signal (TRS), and/or synchronization signal block (SSB) may be utilized as reference signals for positioning purposes. The wireless communications device may perform positioning measurements (e.g. measure a positioning parameter) on the reference signals received. The positioning measurements may be timing-based (e.g., TOA, Relative TOA (RTOA), UTDOA, etc.) and/or signal strength-based (e.g. reference signal received power (RSRP), received signal strength indication (RSSI), etc.). The positioning measurements may be collected in a measurement report sent to a serving cell or to a positioning computation node.

In another embodiment, the network nodes may employ beam sweeping to transmit reference signals. Accordingly, the measurement report may also include beam-related information. As mentioned above, the beam-related information may include identification of preferred or selected beam pairs. A beam pair may indicate a correspondence between a transmit beam of a network node and a receive beam of the wireless communications device.

The wireless communications device may transmit the measurement report to the serving cell (e.g. the serving network node or RAN node). In another example, the measurement report may also be sent to the positioning computation node, which may be a function of a core network or integrated with the serving network node. In another example, as mentioned above, the serving network may include a similar function as the positioning computation node in order to process the received measurement report. The wireless communications device may also transmit a beam measurement request, which indicates a desire for on-demand positioning using a targeted beam approach. Thus, the wireless communications device may initiate a second step or second phase of a positioning operation that encompasses targeted transmissions of reference signals to the wireless communications device. The first step or first phase may include the periodic transmission and measurement of reference signals described above.

In the second phase, the serving cell may coordinate targeted transmissions with one or more neighboring cells. The one or more neighboring cells may be selected by the wireless communications device and/or the serving cell based on, for example, a quality of measurements in the first phase. The serving cell requests the one or more neighbor cells to transmit reference signals to the wireless communications with a timing based on a desired latency. The serving cell may also report selected beam pairs respectively identified for the one or more neighboring cells by the wireless communications device. Following coordination between the serving cell and the one or more neighboring cells, the serving cell may transmit a configuration to the wireless communications device to enable reception and measurement of the targeted transmissions.

The serving cell and the one or more neighboring cells, in accordance with the configuration, may employ beam sweeping over a set of transmit beams to transmit reference signals to the wireless communications device. The set of transmit beams may be a reduced set of beams compared to a number of beams utilized in for the periodic transmissions in the first step. The set of transmit beams may cover a reduced area compared to the beams used in the first step. That is, the set of transmit beams used for the targeted transmissions may be narrower compared to relatively wider beams used by the cells for the periodic transmissions. In one aspect, the set of transmit beams may be narrow beams that sweep an area substantially similar to a wider beam identified by the wireless communications device in the measurement report. In another aspect, the transmit beams used for the periodic transmissions may have differing antenna configurations from the set of transmit beams used for the targeted transmissions. For instance, the targeted transmissions may employ two antenna ports while the periodic transmission may employ one port.

The wireless communications device may receive the reference signals from the serving cell and the one or more neighboring cells in accordance with the configuration. For instance, the configuration may specify a given timing or measurement occasion for each cell. The configuration may also indicate a beam configuration (e.g. the set of transmit beams) for the cell. At the particular measurement occasion, the wireless communications device receives reference signals from a cell over the set of transmit beams specifically utilized by the cell for that wireless communications device. The wireless communications device may perform positioning measurements, similar to those described above, on the reference signals from the cell as well as from other cells. The wireless communications device may report to measurements to a positioning computation node (e.g. a location server) for computation of a positioning estimate or the wireless communications device may compute the positioning estimate when, for example, locations of the transmit points in the cells are known to the wireless communications device.

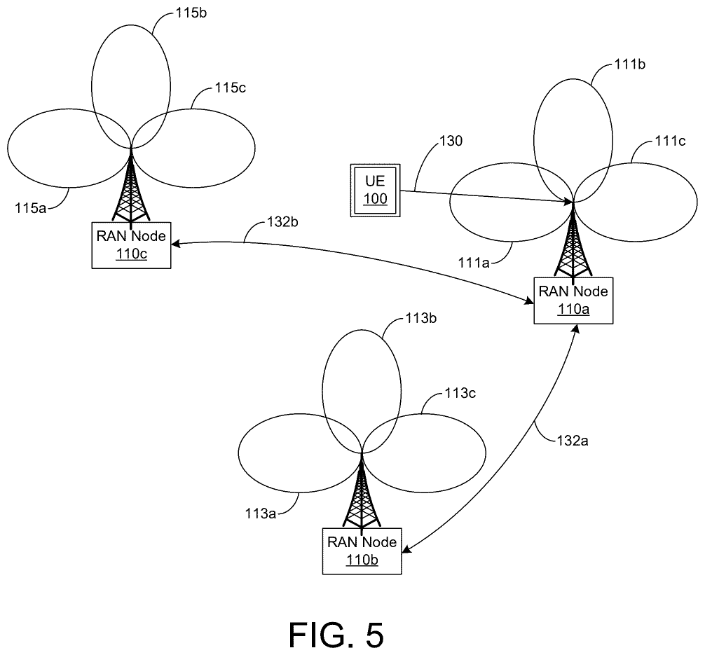

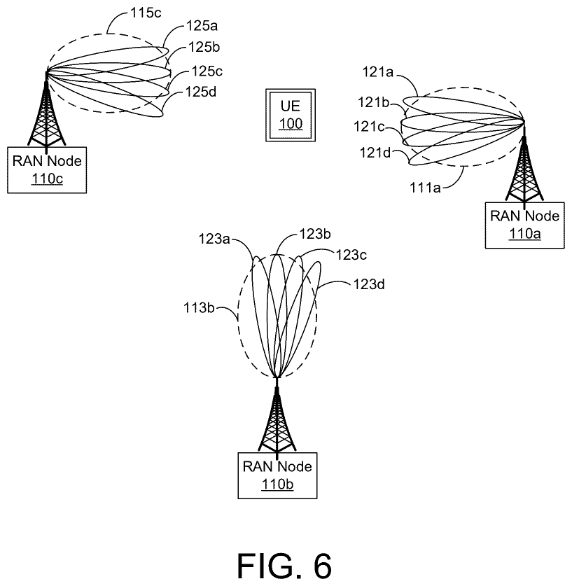

With reference to FIGS. 5 and 6, schematic diagrams of an exemplary positioning technique are illustrated. As described above, the positioning technique disclosed herein may be a two-step process, wherein a first step may provide coarse positioning and a second step may provide refined positioning. FIG. 5 depicts a schematic diagram of the first step. FIG. 5 includes three RAN nodes 110 for simplicity; however, it is to be appreciated that more than three RAN nodes 110 may participate in a positioning operation of UE 100. For the purpose of this description, RAN node 110a is a serving network node providing a serving cell for UE 100 and RAN nodes 110b,c are neighboring network nodes associated with neighboring cells.

The RAN nodes 110 may be configured to transmit reference signals, which may be periodic, via beam sweeping. For instance, RAN nodes 110 repeat transmission of reference signals over a set of configured beams. In FIG. 5, RAN node 110a transmits reference signals using transmit beams 111a-c; RAN node 110b transmits reference signals using beams 113a-c; and RAN node 110c transmits reference signals using beams 115a-c. UE 100 receives the respective reference signals and performs positioning measurements. The positioning measurements may be timing-based and/or signal-strength-based. Additionally, UE 100 identifies a preferred beam associated with each RAN node 110. The UE 100 may identify the preferred beam in a form of beam identification (ID) based on resource ID of the respective reference signals. The preferred beam may be a transmit beam having the best channel conditions and/or the transmit beam associated with the best quality positioning measurements. The preferred beam may include more than one beam. For instance, any transmit beams having channel conditions above a threshold and/or associated with measurements having at least a threshold quality may be selected by UE 100.

UE 100 may perform a positioning measurement based on the obtained measurements. The positioning measurement, however, may be a coarse positioning measurement and may lead to a coarse positioning estimate by the positioning computation node 105, for example. For instance, transmit beams 111, 113, 115 may be relatively wide beams that cover a wider area in order to provide sufficient coverage while also reducing signaling overhead. Accordingly, the positioning measurements and/or a resultant positioning estimate may not achieve an accuracy needed by UE 100. UE 100 may determine whether or not the coarse positioning meets its requirements. The requirements may be an accuracy requirement. In another aspect, the requirements may relate to requirements of the positioning measurement itself. For instance, the requirements may be positioning measurement quality requirements and may relate to signal strength, correlation results, multipath measurement, timing measurement quality, and the like. If requirements are met, the positioning operation may be deemed complete. If the positioning requirements are not satisfied, UE 100 may transmit a request 130 for an on-demand, refined positioning to RAN node 110a (e.g. the serving network node). In particular, the UE 100 may request targeted transmissions from the RAN nodes 110 to UE 100 that are usable for a positioning operation. The targeted transmissions may be specific for UE 100 such that the transmissions are configured for reception by UE 100 and intended to assist positioning of only UE 100. That is, the targeted transmissions are not intended for generic use by any UEs or other communications devices in areas covered by RAN nodes 110.

Along with the request, UE 100 may transmit a measurement report to the RAN node 110a that may include positioning measurements as well as the preferred beams respectively associated with RAN nodes 110a-c. In an aspect, the positioning requirements may be based on properties of the signals used for initial positioning measurements (e.g. SSB-based, PRS with a small bandwidth, PRS with a wider beam, etc.) and/or based on the quality of the initial positioning measurements (e.g. lower correlation value, lower signal strength, etc.). The measurement report may include measurements for the preferred beam, one or more beams having a measurement metric exceeding a threshold, or measurements for all beams. The later example, the RAN node 110a or other network node may determine the preferred beam based on the measurement report.

The serving network node, RAN node 110a, coordinates with the neighboring network nodes, RAN nodes 110b-c. For instance, RAN node 110a may exchange messages 132a-b with RAN node 110b and 110c, respectively. These messages may involve negotiation of transmit occasions by RAN nodes 110 for targeted transmissions of reference signals specific to UE 100. Further, RAN node 110a may communicate the preferred or selected beams, reported by UE 100, to RAN nodes 110b and 110c. Alternatively, the aforementioned coordination can also be managed by the positioning computation node 105. The message exchange may be centralized in the positioning computation node 105.

Turning to FIG. 6, depicted is a schematic diagram of a second step of the positioning operation. In this example, UE 100 reported beams 111a, 113b, and 115c as preferred beams respectively associated with RAN node 110a, 110b, and 110c. In the second step, RAN nodes 110 employ beam sweeping over a set of transmit beams different from the set of transmit beams utilized in the first step (FIG. 5). The set of transmit beams in the second step may be based on the beams in the first step. For example, as shown in FIG. 6, the set of transmit beams in the second step may be narrower than the beams in the first step. More specifically, in an embodiment, the beams in the second step may be a set of narrow beams that collectively cover an area similar to the wider beam selected by UE 100. In FIG. 6, RAN node 110a may employ beam sweeping over a set of transmit beams 121 (e.g. beams 121a-d) correlated with transmit beam 111a; RAN node 110b sweeps over a set of beams 123 (including beams 123a-d) associated with transmit beam 113b; and RAN node 110c may transmit via beam sweeping with a set of beams 125 (having beams 125a-d) associated with beam 115c.

UE 100 performs positioning measurements (e.g. timing-based and/or signal-strength-based) on the reference signals respectively transmitted via beam sets 121, 123, and 125. Measurement values may be reported to a location server (e.g. positioning computation node 105) for positioning estimation and/or utilized by UE 100 to compute a positioning estimate. By transmitting additional reference signals using sets of relatively narrower beams 121, 123, and 125 targeting UE 100, the UE 100 is able to acquire higher quality data (e.g. measurements) with lower latency than available via only the periodic transmissions, which may occur every 20 ms for example. The measurements in the second step may refine the measurements in the first step to produce a more accurate positioning estimate of UE 100.

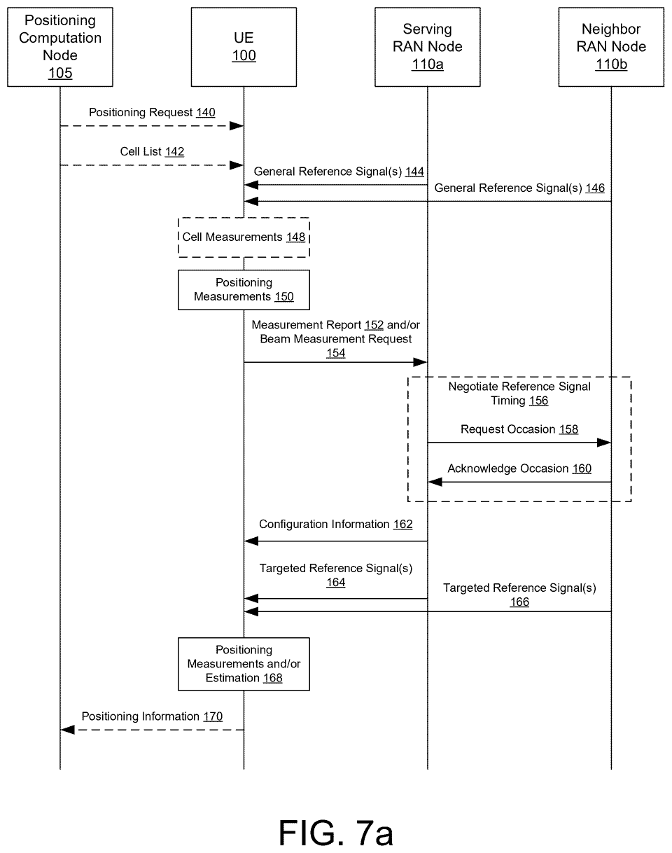

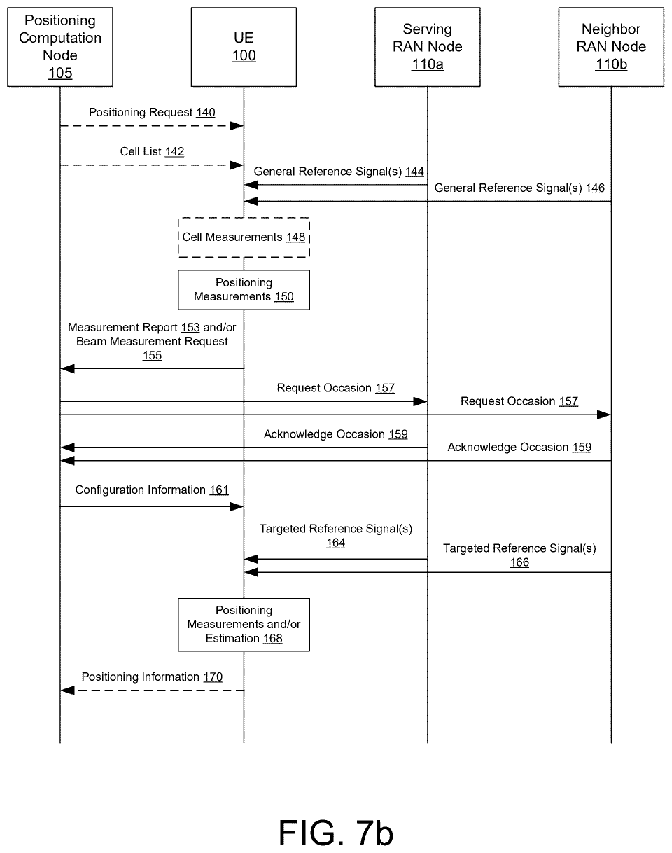

Turning to FIG. 7a, an exemplary signaling diagram for on-demand, two-step positioning of a wireless communications device is depicted. As shown, a positioning computation node 105 may send a positioning request 140 and a cell list 142 to UE 100. The positioning request 140 may trigger UE 100 to perform positioning measurements to support computation of a positioning estimate and the cell list 142 may indicate an initial set of cells or network nodes to be measured by UE 100. In accordance with another aspect, UE 100 may trigger a positioning estimation itself and, thus, the positioning request 140 from the positioning computation node 105 is optional. While shown as a separate node in FIG. 7, it is to be appreciated that the positioning computation node 105 may be co-located with a RAN node, such as serving RAN node 110a, or integrated with the RAN node.

Once a positioning operation is triggered (whether by the positioning computation node 105 or UE 100), a first step is performed. In the first step, UE 100 receives general reference signals 144 and 146 from a serving RAN node 110a and neighbor RAN node 110b. These reference signals are typically periodic and with the purpose to support data transmission, such as synchronization, cell measurement, and channel quality measurement. While FIG. 7 illustrates a single neighbor RAN node 110b, the positioning operation may include multiple neighboring network nodes and the signaling associated with RAN node 110b may replicated accordingly for additional neighbor network nodes.

The general reference signals 144, 146 may be SSB, CSI-RS, PRS, or another signal usable for positioning and may be transmitted by RAN nodes 110a-b using beam sweeping over respective sets of transmit beams. In an optional step, UE 100 may perform cell measurements 148 based on the received reference signals 144, 146. In one aspect, the cell measurements 148 may include reference signal received power (RSRP) measurements and operate to reduce a number of cells measured for positioning from those included in the cell list 142. In another aspect, the RSRP measurements may be utilized by UE 100 to select respective preferred beams for the RAN nodes 110. As described above, the preferred beam associated with general reference signals 144, 146 may be a coarse or wide beam, which is not specific to UE 100.

UE 100 performs positioning measurements 150 on the reference signals 144, 146. The positioning measurements may be timing-based and/or signal-strength-based measurements. UE 100 may transmit a measurement report 152 and/or a beam measurement request 154 to serving RAN node 110a. The measurement report 152 may include the positioning measurements 150 on the reference signals 144, 146. In addition, the measurement report 152 may include a selection of RAN nodes (e.g. based on cell measurements 148) and respective preferred beams identified for those RAN nodes. In a further aspect, UE 100 may determine whether the positioning measurements 150 based on the general reference signals 144, 146 support a positioning estimate that satisfies any positioning requirements (e.g. accuracy requirements). If such requirements are satisfied, then additional steps may be bypassed. If the requirements are not satisfied, UE 100 may request targeted transmissions of reference signals via the beam measurement request 154 in order to refine positioning.

As mentioned above, the positioning computation node 105 may be co-located with serving RAN node 110a, or integrated with the serving RAN node 110a. In accordance with a further aspect, the serving RAN node 110 may also include a similar function of positioning computation node 105. That is, the serving RAN node 110a may be a positioning computation node 105 with limited functionality. For example, the RAN node 110a may include functionality that enables it to receive and process the positioning measurements in measurement report 152. Based on the measurement and post-processing, the serving RAN node 110a can signal and coordinate with the other RAN node 110b as described below.

Based on the measurement report 152 and/or in response to the beam measurement request 154, the serving RAN node 110a may begin preparations for a second step of the on-demand, two-step positioning of UE 100. As shown in FIG. 7, the serving RAN node 110a negotiates reference signal timing 156 with neighbor RAN node 110b. In one example, the serving RAN node 110a may send a request for a particular transmit occasion 158 to the neighbor RAN node 110b. If acceptable, the neighbor RAN node 110b may acknowledge the occasion 160. If the requested occasion is not acceptable, the neighbor RAN node 110b may respond with a rejection, which triggers the serving RAN node 110a to request a different occasion. This process may repeat until an occasion is acknowledged. The neighbor RAN node 110b may provide, in advance, a list of allowed transmit occasions to the serving RAN node 110a. The request 158 may include an occasion selected from this list. In another example, the selection of a transmit occasion may be made by the neighbor RAN node 110b. For instance, the neighbor RAN node 110b may select an occasion in response to a request from the serving RAN node 110a. The serving RAN node 110a may acknowledge or reject the occasion selected by the neighbor RAN node 110b. A rejection may trigger a reselection and such reselections may repeat until a selected occasion is acknowledged.

Following the negotiation at 156, the serving RAN node 110a transmits configuration information 162 to UE 100. The configuration information 162 informs UE 100 of transmit occasions and beam configurations for targeted reference signals by the serving RAN node 110a and neighboring RAN nodes such as neighbor RAN node 110b. The beam configuration may contain the association of the subsequent reference signal(s) 164, 166 and possible relation to the previous reference signal 144, 146. Furthermore, this may be in a form of transmission configuration indicator (TCI) state information. For example, based on this beam configuration the UE can assume that the subsequent reference signal(s) 164, 166 and the previous reference signal 144, 146 have a similar configuration, such as the same Quasi Co-location type (QCL). The serving RAN node 110a transmits targeted references signals 164 and the neighbor RAN node 110b transmit targeted reference signals 166. The targeted reference signals 164 and 166 may be transmitted using beam sweeping of a set of transmit beams. As described above, the set of transmit beams may be based on the preferred beams reported by UE 100. For instance, the set of transmit beams may be a set of narrower beams (relative to the reported preferred beams) such that beam sweeping of the sets cover similar areas to the preferred beams.

Based on the targeted reference signals 164 and 166, UE 100 performs positioning measurements and/or estimation 168. The positioning measurements may be timing-based and/or signal-strength-based. When locations are known for the serving RAN node 110a, neighbor RAN node 110b, and other neighboring RAN nodes measured, UE 100 may compute a positioning estimate. The UE 100 may send positioning information 170 (e.g. a positioning estimate and/or a measurement report) to the positioning computation node 105.

Turning to FIG. 7b, an exemplary signaling diagram for another embodiment of on-demand, two-step positioning of a wireless communications device is depicted. For the purpose of this discussion, description of the portions of this embodiment that are similar to FIG. 7a (noted by similar reference numerals) is omitted. According to an aspect, FIG. 7a depicts an embodiment where the serving RAN node 110a coordinates targeted transmission of reference signals for UE 100. In FIG. 7b, coordination and configuration of the targeted transmission may be handled by the positioning computation node 105. For example, following positioning measurement 150, UE 100 may transmit a measurement report 153 and/or a beam measurement request 155 to the positioning computation node 105. The measurement report 153 and beam measurement request 155 may be similar (e.g. include similar information) as measurement report 152 and beam measurement request 154 described above with regard to FIG. 7a.

Based on the measurement report 153 and/or in response to the beam measurement request 155, the positioning computation node 105 may coordinate the second step of the on-demand, two-step positioning of UE 100. As shown in FIG. 7b, the positioning computation node 105 negotiates reference signal timing with the serving RAN node 110a neighbor RAN node 110b. In one example, the positioning computation node 105 may send respective requests for a particular transmit occasion 157 to the serving RAN node 110a and the neighbor RAN node 110b. If the requested occasions are acceptable, the serving RAN node 110a and the neighbor RAN node 110b may send respective acknowledgments 159 to the positioning computation node 105. If a requested occasion is not acceptable, the serving RAN node 110a and/or the neighbor RAN node 110b may respond with a rejection, which triggers the positioning computation node 105 to request a different occasion. This process may repeat until an occasion is acknowledged by the serving RAN node 110a and the neighbor RAN node 110b. As described above, in another embodiment, the serving RAN node 110a and the neighbor RAN node 110b may provide, in advance, a list of allowed transmit occasions to the positioning computation node 105. Accordingly, the requests 157 may include occasions selected from the respective lists. In another example, the selection of transmit occasions may be made by the serving RAN node 110a and the neighbor RAN node 110b. For instance, the serving RAN node 110a and the neighbor RAN node 110b may select respective occasions in response to requests from the positioning computation node 105. The positioning computation node 105 may acknowledge or reject the occasions selected by the serving RAN node 110a and neighbor RAN node 110b. A rejection may trigger reselection and such reselections may repeat until selected occasions are acknowledged by the positioning computation node 105.

Following the coordination described above, the positioning computation node 105 transmits configuration information 161 to UE 100. The configuration information 161 may be similar to configuration information 162 described above. For instance, the configuration information 161 informs UE 100 of transmit occasions and beam configurations for targeted reference signals by the serving RAN node 110a and neighboring RAN nodes such as neighbor RAN node 110b.

It is to be appreciated that the above sequences described in FIGS. 7a-b are exemplary and alternative orders may be employed in the respective sequences.

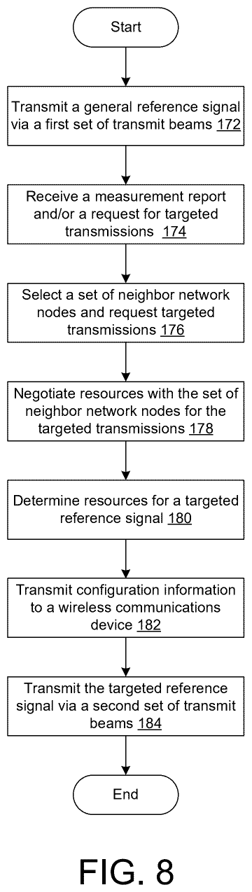

FIGS. 8-10 illustrate exemplary process flows representing steps that may be embodied by UE 100 and network nodes 110. Although illustrated in a logical progression, the illustrated blocks of FIGS. 8-10 may be carried out in other orders and/or with concurrence between two or more blocks. Therefore, the illustrated flow diagrams may be altered (including omitting steps) and/or may be implemented in an object-oriented manner or in a state-oriented manner.

FIG. 8 illustrates a representative method for on-demand, two-step positioning of a wireless communications device. The method of FIG. 8 may be carried out by a network node, such as serving RAN node 110a. The logical flow may start at block 172 where the serving network node transmits a general reference signal via a first set of transmit beams. The general reference signal is typically periodic and for the purpose to support data transmission, such as synchronization, cell measurement, and channel quality measurement. The first set of transmit beams may include relatively wider, coarse beams configured to generically provide coverage to any UEs in an area without significant signaling overhead. As described above, transmission of general reference signals may be a first step of the two-step positioning operation. In block 174, the serving network node receives, from the wireless communications device, a measurement report and/or a request for targeted transmissions of reference signals. The measurement report includes positioning measurements of the general reference signal from the serving network node as well as positioning measurements of general reference signals from one or more neighboring network nodes. The measurement report may also include identification of a preferred or selected beam associated with the serving network node and the one or more neighboring network nodes. The preferred beams may be selected based on signal strength metrics or other measurements.

In block 176, a set of neighbor network nodes are selected and the serving network node requests targeted transmissions from the selected nodes to the wireless communications device. The set of neighbor network nodes may be selected by the wireless communications device and identified in the measurement report. In another embodiment, the serving network node selects the neighbor network nodes based on the measurement values in the report, for example.

In block 178, the serving network node negotiates resources for the targeted transmissions with the set of neighbor network nodes. In one example, the serving network node may request a particular transmit occasion from a neighbor network node and the neighbor network node may acknowledge or reject the requested occasion. A rejection may trigger a request of a different transmit occasion until an acknowledgement is received. In another approach, the neighbor network node may choose a transmit occasion, which is subsequently acknowledged or rejected by the serving network node. In block 180, the serving network node determines resources for its own targeted reference signals to be transmitted to the wireless communication device. In block 182, the serving network node transmits configuration information to the wireless communications device, which may indicate the respective transmit occasions and beam configurations for the targeted references signals from the serving network node and the set of selected neighbor network nodes. In block 184, the serving network node transmit targeted reference signals via a second set of transmit beams. The second set of transmit beams may be based on the preferred beam reported by the wireless communications device from the first set of transmit beams utilized in block 172. For instance, the second set of transmit beams may be a set of narrower beams correlated with the preferred beam. In one example, the second set of transmit beams may collectively cover an area substantially similar to the area covered by the preferred beam. The targeted reference signals transmitted via the second set of transmit beams enable the wireless communications device to acquire positioning measurements that support a positioning estimate with higher accuracy than the measurements based on general reference signals.

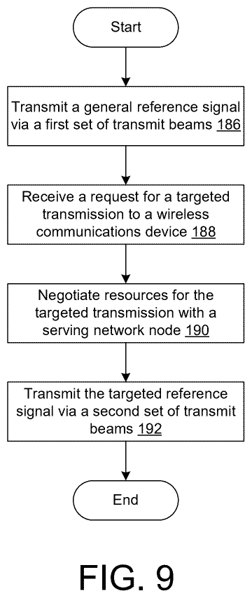

Turning to FIG. 9, a representative method for on-demand, two-step positioning of a wireless communications device is provided. The method of FIG. 9 may be carried out by a neighbor network node, such as RAN nodes 110b-c. The logical flow may start at block 186 where the neighbor network node transmits a general reference signal via a first set of transmit beams. The general reference signal is typically periodic and for the purpose to support data transmission, such as synchronization, cell measurement, and channel quality measurement. The first set of transmit beams may include relatively wider, coarse beams configured to generically provide coverage to any UEs in an area without significant signaling overhead. In block 188, the neighbor network node may receive a request from a serving network node to transmit targeted reference signals to a specific wireless communications device. The request may indicate a selected transmit beam from the first set of transmit beams, which was reported by the wireless communications device as a preferred beam.

In block 190, the neighbor network node negotiates resources for the targeted transmissions with the serving network node. In one example, the serving network node may request a particular transmit occasion from the neighbor network node and the neighbor network node may acknowledge or reject the requested occasion. A rejection may trigger a request of a different transmit occasion until acknowledgement by the neighbor network node. In another approach, the neighbor network node may choose a transmit occasion, which is subsequently acknowledged or rejected by the serving network node. In block 192, the neighbor network node transmits targeted reference signals via a second set of transmit beams. The second set of transmit beams may be based on the preferred beam reported by the wireless communications device from the first set of transmit beams utilized in block 186. For instance, the second set of transmit beams may be a set of narrower beams correlated with the preferred beam. In one example, the second set of transmit beams may collectively cover an area substantially similar to the area covered by the preferred beam. The transmission via the second set of transmit beams is the second step of the positioning operation, which may refine the positioning of the wireless communications device.

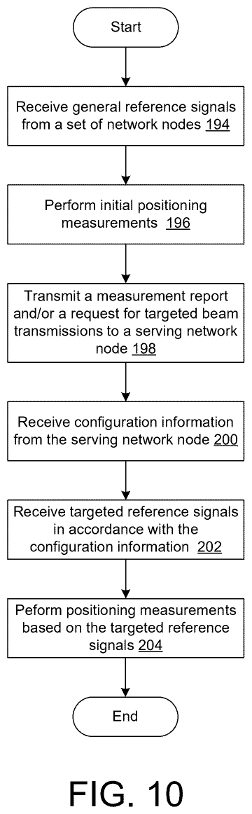

FIG. 10 illustrates a representative method for on-demand, two-step positioning of a wireless communications device. The method of FIG. 10 may be carried out by a wireless communication device, such as UE 100. The logical flow may start at block 194 where the wireless communications device may receive general reference signals from a set of network nodes. These reference signals are typically periodic and for the purpose to support data transmission, such as synchronization, cell measurement, and channel quality measurement. The set of network nodes may include a serving network node and one or more neighbor network nodes. Each network node may transmit the general reference signals using a first set of transmit beams. The first set of transmit beams may include relatively wider, coarse beams configured to generically provide coverage to any UEs in an area without significant signaling overhead.

In block 196, the wireless communications device performs initial positioning measurements on the general reference signals received. In addition, the wireless communications device may select respective preferred beams for the set of network nodes. The positioning measurements may be timing-based or signal-strength-based. In an example, the preferred beams may be selected based on RSRP measurements of the periodic reference signals.

In block 198, the wireless communications device may transmit, to the serving network node, a measurement report and/or a request for targeted transmission of reference signals. The measurement report may include the initial positioning measurements and/or identification of the preferred beams. The initial positioning measurements may not have sufficient quality to achieve a desired accuracy. Thus, the wireless communications device may request a second step of the positioning operation, which is targeted and specific to the wireless communications device, to refine the positioning.

In block 200, the wireless communications device may receive configuration information from the serving network node. The configuration information may indicate respective transmit occasions and beam configurations for targeted reference signals from the serving network node and a set of selected neighbor network nodes. In block 202, based on the configuration information, the wireless communications device may receive targeted reference signals from the serving network node and the set of selected neighbor network nodes. Each network node may transmit the targeted reference signals via a second set of transmit beams, which are related to the preferred beam selected by the wireless communications device. For instance, the second set of transmit beams may be a set of narrower beams correlated with the preferred beam. In one example, the second set of transmit beams may collectively cover an area substantially similar to the area covered by the preferred beam.

In block 202, the wireless communications device may perform positioning measurement based on the targeted reference signals received. The positioning measurements may be used to compute a positioning estimate for the wireless communications device. As the reference signals are specific and targeted to the wireless communications device, the positioning estimate should have a greater accuracy compared to an estimate based on the periodic reference signals alone.

### CONCLUSION

Although certain embodiments have been shown and described, it is understood that equivalents and modifications falling within the scope of the appended claims will occur to others who are skilled in the art upon the reading and understanding of this specification.

What is claimed is:

1. A method performed by a wireless communications device for positioning of the wireless communications device, comprising:
receiving one or more reference signals from a first set of network nodes of a plurality of network nodes;
performing initial positioning measurements on the one or more reference signals;
receiving configuration information for transmissions of specific reference signals from a second set of network nodes of the plurality of network nodes usable for a positioning operation, the specific reference signals being associated with the wireless communications device, the second set of network nodes are identified after the initial positioning measurements of the one or more reference signals from the first set of network nodes;
receiving one or more specific reference signals respectively from the second set of network nodes based on the configuration information; and
performing positioning measurements on the one or more specific reference signals received.

2. The method of claim 1, further comprising, prior to receiving the configuration information:
transmitting a measurement report to a serving network node.

3. The method of claim 2, further comprising transmitting a beam measurement request to the serving network node for transmission of the specific reference signals from the second set of network nodes identified.

4. The method of claim 2, wherein the measurement report identifies selected transmit beams on which the wireless communications device respectively receives reference signals from the first set of network nodes, the selected transmit beams indicate preferred beams to assist configuration of the transmissions of the specific reference signals.

5. The method of claim 1, wherein receiving the one or more specific reference signals further comprises receiving the one or more specific reference signals on respective sets of transmit beams from the second set of network nodes.

6. The method of claim 5, wherein the configuration information includes an association of the respective sets of transmit beams to selected transmit beams.

7. The method of claim 1, wherein the configuration information includes at least respective resource information for the one or more specific reference signals respectively transmitted by the second set of network nodes.

8. A method for facilitating positioning of a wireless communications device performed by a network node, comprising:
transmitting a reference signal via a first set of transmit beams; and
transmitting a specific reference signal associated with the wireless communications device via a second set of transmit beams, wherein transmitting the specific reference signal is based at least in part on initial positioning measurements reported by the wireless communications device after receiving the reference signal and includes transmitting the specific reference signal with specific reference signals transmitted by a set of neighbor network nodes identified after the initial positioning measurements reported by the wireless communications device after receiving the reference signal, wherein the specific reference signal enables the wireless communications device to perform refined positioning measurements to produce a more accurate positioning estimate.

9. The method of claim 8, wherein the initial positioning measurements reported by the wireless communications device indicates a selected beam from the first set of transmit beams, and
wherein the second set of transmit beams include transmit beams that are determined based on the selected beam.

10. The method of claim 8, further comprising receiving a request to transmit the specific reference signal following transmission of the reference signal.

11. The method of claim 8, wherein the network node is a serving network node and the method further comprises:
receiving a measurement report from the wireless communications device based on reference signal received by the wireless communications device;
determining resources for transmitting the specific reference signal to the wireless communications device based at least in part on the measurement report; and
requesting the set of neighbor network nodes to transmit specific reference signals to the wireless communications device based at least in part on the measurement report.

12. The method of claim 11, wherein the serving network node further performs the steps of:
negotiating resources for transmission of specific reference signals by the set of neighbor network nodes; and
transmitting configuration information to the wireless communications device that indicates at least resources determined for transmissions of specific reference signals by the serving network node and the set of neighbor network nodes.

13. The method of claim 11, further comprising selecting the set of neighbor network nodes based at least in part on the measurement report.

14. A wireless communications device configured to operate in a wireless communications network, comprising:
a wireless interface over which wireless communications with one or more network nodes are carried out; and
a control circuit configured to:
receive one or more reference signals from a first set of network nodes of a plurality of network nodes;
perform initial positioning measurements on the one or more reference signals;
receive configuration information for transmissions of specific reference signals from a second set of network nodes of the plurality of network nodes usable for a positioning operation, the specific reference signals being associated with the wireless communications device, the second set of network nodes are identified after the initial positioning measurements of the one or more reference signals from the first set of network nodes;
receive one or more specific reference signals respectively from the second set of network nodes based on the configuration information; and
perform positioning measurements on the one or more specific reference signals received.

15. The wireless communications device of claim 14, wherein, prior to receiving the configuration information, the control circuit is further configured to:
transmit a measurement report to a serving network node.

16. The wireless communications device of claim 15, wherein the control circuit is further configured to transmit a beam measurement request to the serving network node for transmission of the specific reference signals from the second set of network nodes identified.

17. The wireless communications device of claim 15, wherein the measurement report identifies selected transmit beams on which the wireless communications device respectively receives reference signals from the first set of network nodes, the selected transmit beams indicate preferred beams to assist configuration of the specific transmissions.

18. The wireless communications device of claim 14, wherein the control circuit is further configured to receive the one or more specific reference signals on respective sets of transmit beams from the second set of network nodes.

19. The wireless communications device of claim 18, wherein the configuration information includes an association of the respective sets of transmit beams to selected transmit beams.

20. The wireless communications device of claim 14, wherein the configuration information includes at least respective resource information for the one or more specific reference signals respectively transmitted by the second set of network nodes.
